(19) United States
(12) Patent Application Publication
(10) Pub. No.: US 2008/0270263 A1
(43) Pub. Date: Oct. 30, 2008

(54) APPARATUS AND METHOD FOR LOCATING DATA

(76) Inventors: Simon Hill, Amersham (GB); Lisa Hill, Amersham (GB)

Correspondence Address: CHRISTIE, PARKER & HALE, LLP, PO BOX 7068, PASADENA, CA, 91109-7068, US

(21) Appl. No.: 12/103,634

(22) Filed: Apr. 15, 2008

(30) Foreign Application Priority Data
Apr. 17, 2007 (GB) 0707358.8

(51) Int. Cl. G06Q 30/00; G06Q 99/00; H04L 9/32; G06F 17/30

(52) U.S. Cl. 705/27; 705/1; 726/7

(57) ABSTRACT

A computer network comprising at least one local terminal, at least one database terminal remote from the or each local terminal and a server database associated with the or each server database terminal, wherein the server database comprises a first table that includes a plurality of images from disparate original sources, each image containing a plurality of products from disparate original sources, a second table that includes data relating to the plurality of products from disparate original sources and a third table that includes information referencing which of the plurality of products appears in which of the plurality of images.

### TECHNICAL FIELD

This invention relates to a method and apparatus for locating data. In particular, it relates to a method and apparatus for storing, cross-linking and locating data of a visual nature that exists across multiple disparate sources. Most particularly, it relates to a method and apparatus that allows a user to locate ideas and products for artistic design purposes over the Internet, where the ideas and products exist across multiple disparate websites.

### BACKGROUND OF THE INVENTION AND TECHNICAL PROBLEMS POSED BY THE PRIOR ART

It is now extremely common for consumers to use Internet websites to locate, research, compare and purchase products and services. There are numerous websites currently available to consumers and these generally comprise either supplier directory websites or product directory websites.

Supplier directory websites contain listings of links to multiple different supplier websites, much like a business telephone directory, so that a consumer may view a list of suppliers that offer a specific product type or service. Product directory websites contain listings of products from multiple suppliers aggregated into one website. The suppliers provide the product directory website with product information that is categorised so that products or services may be filtered by type and/or sub-type.

A major limitation of these websites is that they do not have the capacity to aid consumers in a design process. For example, a user renovating or furnishing a room in a property may be able to locate an individual product in isolation using these existing websites, but there is no means provided by which they may consider the appearance of combinations of coordinating products in an environment similar to that of the user's own home or design concepts such as style, colour, materials, light, use of space, function, room dressing, etc. The websites only deal with the product aspect of design and force consumers to consider each product individually, out of context of the holistic design.

The present invention provides an improved and innovative means for consumers to locate, mix and match ideas and products for artistic design purposes, without needing to see those ideas and products in real life prior to purchase.

In the present invention, a “scheme” is defined as a collection of products in a designated environment. An example of a scheme in the context of home furnishings may be a photo of a professionally designed interior room of a house or garden containing a plurality of products from one or more disparate suppliers. A further example of a scheme in the context of fashion may be a photo of an individual wearing a plurality of items of clothing from one or more disparate suppliers.

### SUMMARY OF THE INVENTION

According to the present invention in a first aspect, there is provided a computer network comprising at least one local terminal, at least one database terminal remote from the or each local terminal and a server database associated with the or each server database terminal, wherein the server database comprises a first table that includes a plurality of scheme images from disparate original sources, each scheme image containing a plurality of products from disparate original sources, a second table that includes data relating to the plurality of products from disparate original sources and a third table that includes information referencing which of the plurality of products appears in which of the plurality of scheme images.

According to the present invention in another aspect, there is provided a computer network comprising at least one local terminal, at least one database terminal remote from the or each local terminal and a server database associated with the or each server database terminal, wherein the server database comprises a “scheme” table that includes a plurality of schemes from disparate original sources, each scheme record including one or more images of the scheme showing a plurality of products from disparate original sources and one or more further metadata fields representative of the characteristics of the scheme, a “product” table that includes data relating to the plurality of products from disparate original sources, each product record including one or more images of the product and one or more further metadata fields representative of the characteristics of the product, a “grouping” table that includes relational data that links product records with scheme records whose images show those products and where any individual product may appear in any number of schemes, and a “stock” table that includes details of a plurality of suppliers that stock the products.

Preferably, the or each local terminal and the or each database terminal are arranged to communicate with each other through the Internet, and the plurality of disparate original sources from which the products are taken comprises a plurality of disparate original websites. Accordingly, by virtue of the present invention a user may effectively locate ideas and products, which exist across multiple disparate websites, which websites may be owned/operated by different vendors or companies, for artistic design purposes over the Internet. The user may, for example, consider the appearance of combinations of coordinating products from disparate websites in an environment similar to that of their own home, or may consider design concepts such as style, colour, materials, light, use of space, function, room dressing, etc.

According to the present invention in another aspect, there is provided a method of locating artistic design ideas using the computer networks detailed above, comprising the steps of: inputting search criteria at the local terminal to locate scheme images stored on the database terminal; and selecting one of the scheme images.

According to the present invention in a further aspect, there is provided a method of selecting a product using the computer networks detailed above, comprising the steps of: inputting search criteria at the local terminal to locate a scheme image stored on the database terminal; and selecting a product located within the image.

According to the present invention in a further aspect, there is provided a method of refining a product selection using the computer networks detailed above, comprising the steps of: locating a product using the above method; choosing to view other products stored on the database terminal with the same or similar characteristics as the initial product selection; and selecting an alternative product.

According to the present invention in a further aspect, there is provided a method of assisting a product selection using the computer networks detailed above, comprising the steps of: locating a product using one of the above methods; and choosing to view those scheme images stored on the database terminal that include the product.

According to the present invention in a further aspect, there is provided a method of populating a database using the computer networks detailed above, comprising the steps of: registering a “content owner” user on the database; allocating the user a username and password; providing the user at least partial access to the database when logged on to the database server from the or each local terminal, so that the user may upload data to the database; and at least partially validating data uploaded by the user.

According to the present invention in a further aspect, there is provided a method of automatically validating data uploaded by “content owner” users and processing and re-forming that data into the database terminal's relational model.

According to the present invention in a further aspect, there is provided a method enabling a consumer to select goods, comprising the steps of: populating a database with products from a plurality of disparate sources; populating a database with schemes from a plurality of disparate sources; arranging the products into groups where each group is represented by a scheme; providing a means by which the consumer may search the images of grouped products using image and/or product identifiers; and providing means by which the consumer may select a desired product from a selected group.

According to the present invention in a further aspect, there is provided a database, populated with a plurality of schemes, each including data representative of a plurality of products brought together to form a scheme having desired characteristics, the database including one or more further fields representative of individual items forming part of the scheme.

According to the present invention in yet a further aspect, there is provided a product selection system comprising a server means and a database as detailed above, wherein the server means is adapted to provide to a remote user terminal, data representative of a scheme and/or the further fields.

There is further provided a computer network comprising at least one local terminal, at least one database terminal remote from the or each local terminal and a server database associated with the or each server database terminal, wherein the server database comprises a first table that includes a plurality of images from disparate original sources, each image containing a plurality of products, and a product table that includes details of the plurality of products located within the images.

There is further provided a computer network comprising at least one local terminal, at least one database terminal remote from the or each local terminal and a server database associated with the or each server database terminal, wherein the server database comprises a “scheme” table that includes a plurality of schemes from disparate original sources, each scheme record including one or more images of the scheme showing a plurality of products and one or more further fields representative of the characteristics of the scheme, a “product” table that includes details of the plurality of products located within the scheme images, a “grouping” table that includes relational data of schemes and products, and a “stock” table that includes details of a plurality of suppliers that stock the products.

There is further provided a method enabling a consumer to select goods, comprising the steps of: populating a database with products from a plurality of disparate sources, there being an image associated with each of the products; arranging the products in groups and generating images of grouped products; providing a means by which the consumer may search the images of grouped products using image and/or product identifiers; and providing means by which the consumer may select a desired product from a selected group.

### BRIEF DESCRIPTION OF THE DRAWINGS

Embodiments of the present invention will now be described, by way of example only, with reference to the accompanying drawings in which:

FIG. 1 shows a relational data model;

FIG. 2 shows the process flow of a user utilising the present invention to locate data;

FIG. 3 shows representations of a user's screen through the process flow of FIG. 2;

FIG. 4 shows the process flow of a designer/publisher uploading scheme data to the database;

FIG. 5 shows the process flow of a manufacturer/supplier uploading product data to the database; and

FIG. 6 shows a schematic of a computer network.

### DETAILED DESCRIPTION OF THE INVENTION

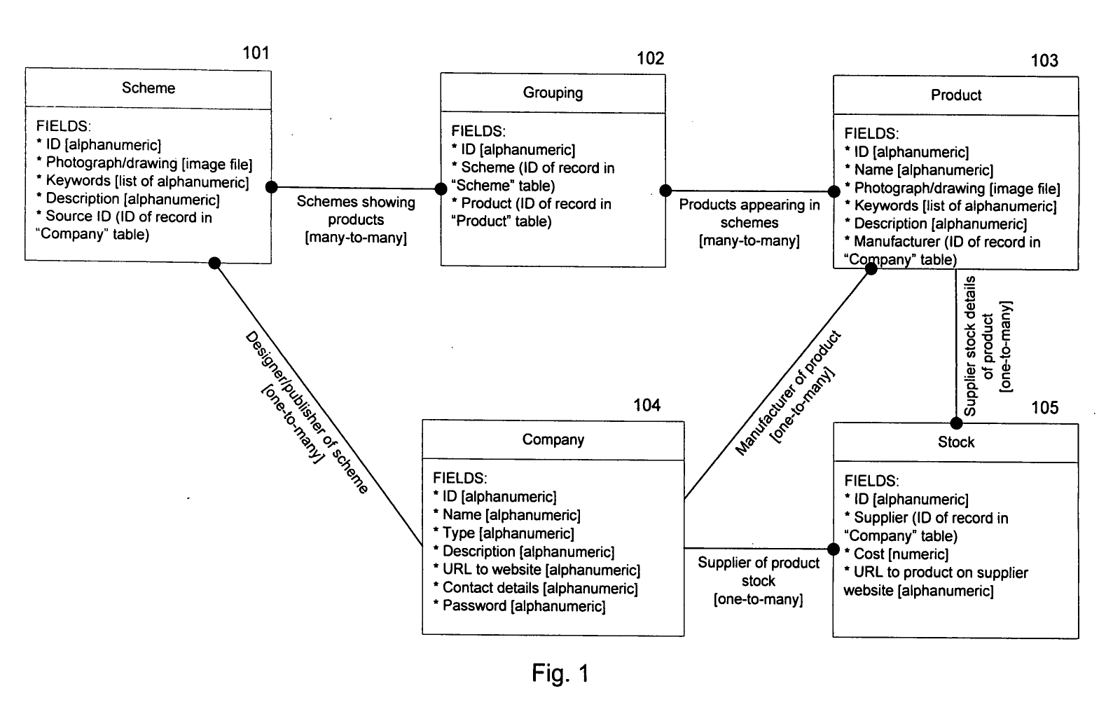

Referring to FIG. 1 there is shown a relational database located on a server according to a first embodiment of the present invention. The database includes a scheme table 101, a grouping table 102, a product table 103, a company table 104 and a stock table 105.

In the present embodiment, the schemes are either images of interior design schemes showing complete rooms or images containing multiple products from one or more manufacturers and/or suppliers. The scheme table 101 is populated with a number of these scheme images. For each scheme image there is an identifier provided along with a list of keywords and a description. Any further relevant information may be provided.

Each of the schemes comprises a number of products. The product table 103 is populated with the details of the products visible in the scheme images. For each product there is provided an identifier, a name, an image, a list of keywords and manufacturer and/or supplier details along with any further relevant information.

The grouping table 102 is populated with details of which products appear in which schemes. For example, if products P1, P2 and P3 appear in scheme S1 and products P1 and P4 appear in scheme S2, then this will be expressed by five records in the grouping table. The first record will contain the ID of product P1 and scheme S1, the second record will contain the ID of product P2 and scheme S1, the third record will contain the ID of product P3 and scheme S1, the fourth record will contain the ID of product P1 and scheme S2 and the fifth record will contain the ID of product P4 and scheme S2.

For each of the products listed in the product table 103 there is stock information provided. The stock table 105 is populated with this stock information, which includes but is not limited to an identifier, supplier details, cost information and a link to the product on an external (supplier) website, wherein the external website represents a disparate source from which the product is available.

The grouping table may be populated manually (or partially manually) or automatically. Manual population involves the service provider manually viewing every scheme image, to identify the products from those images (and/or possible alternatives) and then to add appropriate information, keywords, hyperlinks, etc into the server system. This is in fact an added value service as it adds human aesthetic input to create a design service.

The company table 104 is populated with details relating to the manufacturers and/or suppliers of the products populating the product table 103 and the designers/publishers of the schemes in table 101. For each company there is provided an identifier, a name, a website link and contact details along with any further relevant information. The company table also preferably contains a password for each company, which permits the company to log on to the system and upload information.

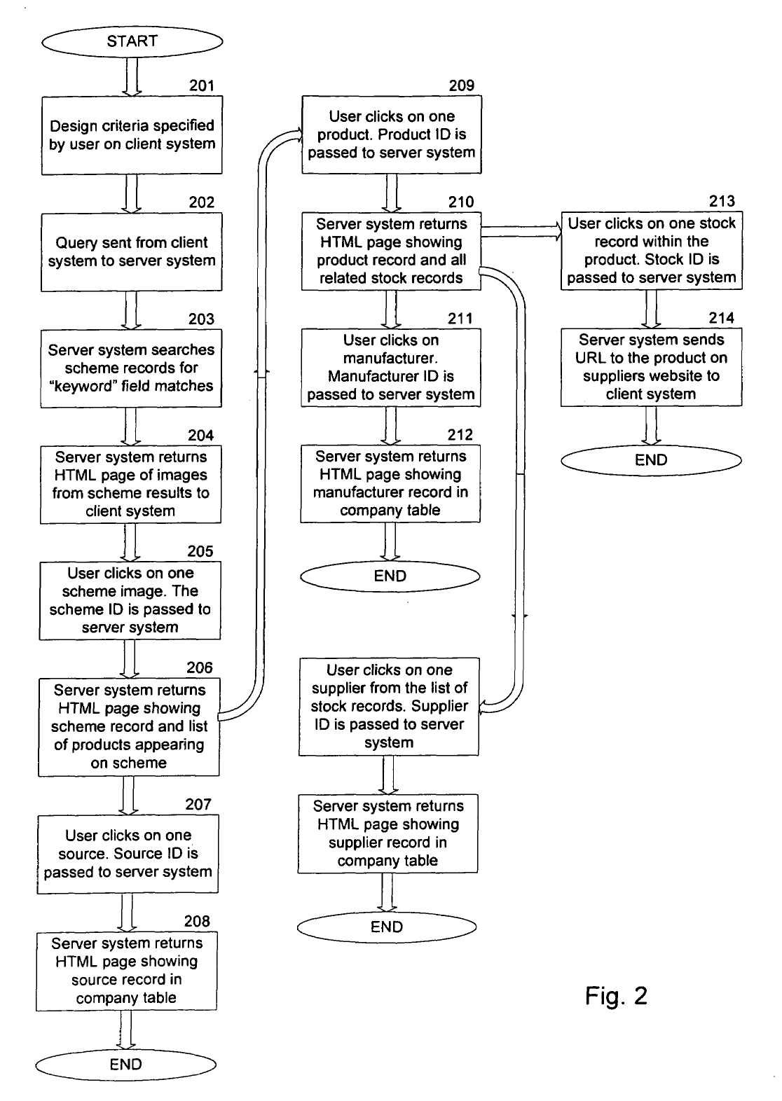

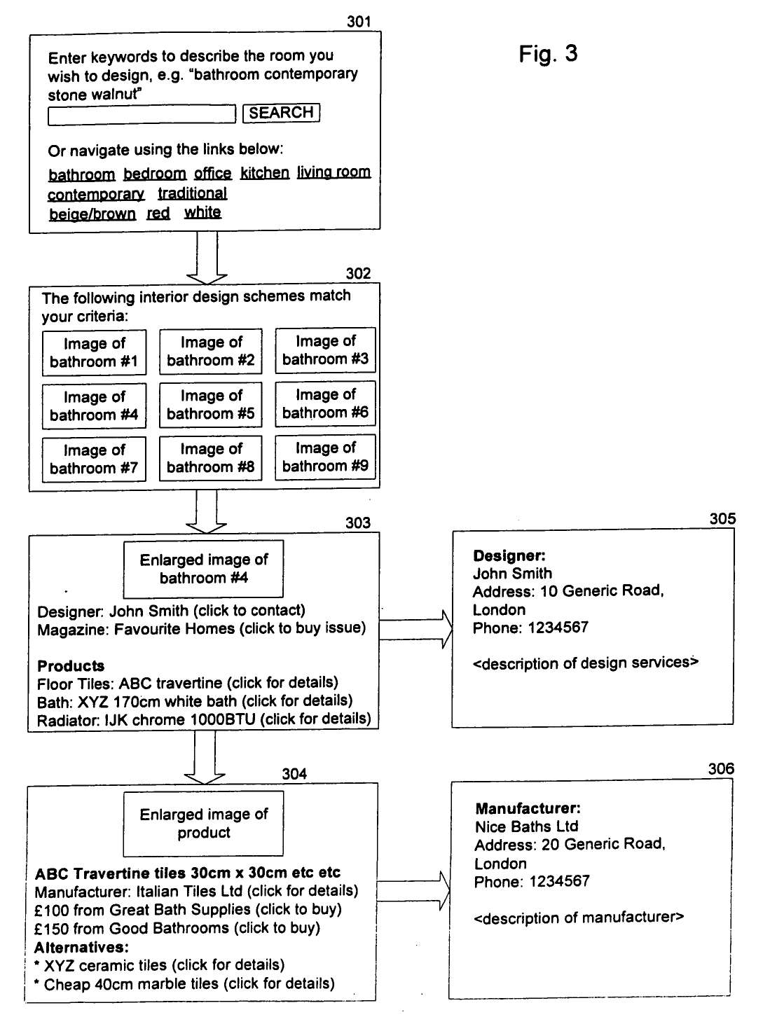

Referring to FIG. 2 there is shown a process flow of a user using the present invention according to the embodiment detailed above. A set of design criteria is specified by the user at a client system—in the present example this is a set of descriptive keywords. The keywords are received at the server system 202 and the server searches through all scheme records in the scheme table 101 for situations where one or more of the keywords matches the keywords received from the client system 203. The results are returned from the server in prioritised form, such that the scheme record(s) with the most matching keywords are provided first. The results comprise an HTML page that shows thumbnails of the of the relevant scheme images (302, FIG. 3).

It is preferable that the search also covers the records stored in the product table 103, with the results returned in the same HTML page as the results of the search of the scheme table 101. A user then has the option of viewing schemes or the products directly.

In response to the user selecting a search result—in the present example an image, the client system sends a record ID of the image to the server system 205. The server system then returns a page of HTML to the client system showing the detail of the scheme record 206 and a full size image and description of the scheme.

Preferably, there is a link provided on this HTML page to each of the relevant sources from the company table 104. There may be multiple sources provided for each scheme, including but not limited to details of a publication in which the image featured, details of the image designer and details of the manufacturer(s) of the products in the scheme image. Upon clicking a link, a request is sent from the client system to the server system containing the ID of the source record 207 and the server system returns an HTML page containing details stored within the source record 208. Alternatively, the HTML page of the scheme 206 may display the source details such that no additional request is required by the user. Such an arrangement would be preferable where the data in the source record is sufficiently small that a further HTML page would not be warranted.

The scheme HTML page 206 also contains the name fields from the products within the image. This information is obtained through the grouping records associated with the scheme record. In response to the user selecting one of the product names, the client system returns the ID of the product record to the server system 209. The server system then composes an HTML page containing details from the product record whose ID was received by the server system. The server system looks up a list of records from the stock table 105 associated with the product record and the corresponding company record for each stock record is returned. The HTML page preferably has appended to it a list of companies supplying the product, stock details and the price. The HTML page is returned to the client system 210.

Preferably, on this HTML page there is provided a link to the product manufacturer. If the user clicks this link, a request is sent from the client system to the server system containing the ID of company record that represents the manufacturer 211 and the server system returns an HTML page containing the details within the company record 212. Alternatively, the HTML page of the product 210 may include the manufacturer details, such that an additional HTML page is unnecessary. This is preferable when the data in the company record is sufficiently small that it does not warrant its own HTML page.

The product HTML page 210 contains a list of suppliers who stock the product and their price. In response to the user clicking on one of these suppliers, the client system returns the ID of the stock to the record to the server system 213 and the server system 213 returns the URL of the product item on the supplier's website to the client system 214.

Referring to FIG. 3 there is shown a specific example of the present invention showing the user's screen through the process flow detailed above.

A user on a client system connects to a website on a server system through the Internet. The user is planning to redecorate a bathroom. The user either specifies the design criteria of “bathroom”, “contemporary”, “stone” and “walnut” in the search bar and clicks “search” or uses a number of links provided to limit the number of scheme images (screen 302).

A list of scheme images is returned. Each image features a number of individual products—the images preferably show complete bathrooms populated with the individual products (screen 302). The user may view each of these images in turn. For each image, details relating to the design are displayed. The images originate from a number of disparate sources, having been uploaded by one or more different content owners.

Upon selecting a particular scheme image, a new page is loaded that features an enlarged image (screen 303). The user may click on the source links, for example, to contact the designer or to visit the website of a magazine from which the image is taken (screen 305). Alternatively, the user may wish to select an individual product within the image.

In the present example, the user selects the tiles and a new page is loaded that features an enlarged image of the tiles (screen 304). The user may click on the stock/company links to view details of the manufacturer and/or select an external supplier from whom they may purchase the tiles. As shown in screen 304, the products table 103 may comprise additional fields storing links to alternative similar products.

Note that instead of HTML pages, the information may be displayed/generated in other known or future formats, such as XML, pdf or others.

It is preferable that a designer or publisher of schemes can upload, edit or delete schemes on the database from a local terminal on the network.

The designer/publisher preferably initially registers on the database to obtain a username and password (or other authentication data—e.g. digital certificate, smart card, log in data, biometric data, etc). They can then create scheme data using a local terminal. This may comprise a spreadsheet that features one scheme per row with multiple schemes uploaded through FTP or any alternative suitable electronic data transfer method. Alternatively, there may be a website provided that comprises an HTML form enabling the submission of schemes one-by-one. For each scheme, the designer/publisher may specify the location of one or more image files of the scheme, one or more characteristics of the scheme such as a description, a unique “key” for the scheme and a list of product IDs that relate to the products appearing in the scheme. It is preferable that the “key” remains unchanged for each scheme, even if uploaded again or edited.

The upload process preferably automatically validates the scheme data, such validation may include, but is not limited to, ensuring that the unique key is not duplicated within an individual designer/publisher's data and that the products referenced exist within the database. If errors are detected, the system preferably produces an error page/file. Furthermore, in the case that the upload is not the first by the designer/publisher and represents an update to a previous upload, where the present upload is intended to overwrite the earlier upload, there may be additional validation to ensure data integrity between the present and earlier uploads.

The upload process preferably includes at least partial manual validation. In such a case, once a scheme is uploaded by a designer/publisher, the scheme is not publicly visible until it has been reviewed by the service provider to at least ensure integrity of data and content. The service provider may also, in this step, amend the description or referenced products and/or add keywords. In the case that keywords are added, they may be for internal use only so as not to be seen by the designer/publisher. Once validated in this way, the schemes would be “live” to all users.

The upload process automatically creates records in the “grouping” table. Every time a product is associated with a scheme, a record is created in the “grouping” table giving the scheme ID and the product ID. The “grouping” table enables updating of the scheme table and product table, without losing associations between products and schemes, which is a unique advantage of this invention. It is for this reason that the integrity of the product and scheme IDs is preferably retained. Furthermore, in the event a product or scheme is deleted, the related “grouping” records still remain so that if a scheme or product is added back at a later date or the same product is later added by a different supplier or manufacturer, the products are correctly associated with the relevant schemes.

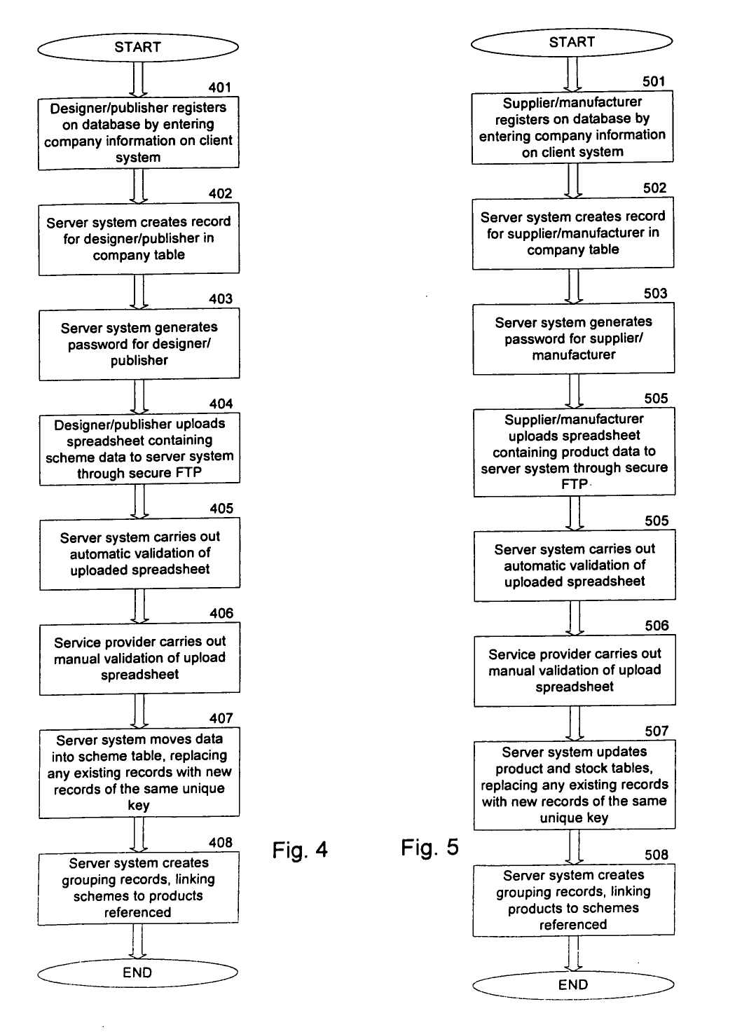

Referring to FIG. 4 there is shown a process flow of an interior design company uploading their design portfolio into the system. The company details are entered on the client system, including company name, website URL and contact details (401). The server system stores these details in the company table (402). The server system generates a password for the interior designer to use to securely upload scheme data (403) and preferably emails the password to the interior design company.

A spreadsheet is created by the interior designer, with one record for each design scheme in their portfolio to be uploaded. Each record contains file locations of a number of image files showing photos of the design scheme, a description of the scheme, a unique key generated by the design company for each scheme, and also a list of the IDs of any of the products present in the scheme that are already within the database. Following login using the name and password provided by the server system, the interior design company may upload the spreadsheet into the system (404).

The server system loops through all the records to check for duplicate unique keys and referenced product IDs that do not exist (405). In this example, the system finds that one unique key is duplicated. The system aborts the upload without moving any of the data into the scheme table 101. The system then sends an email to the design company detailing the error. The design company can then correct the error and upload the spreadsheet again (404).

Upon successful automatic validation of an uploaded scheme 101, the server system emails the service provider to inform them that there is an uploaded scheme awaiting manual validation. Once the service provider has checked through the upload and confirmed that it is acceptable (406) the uploaded data is moved into the scheme table.

Where existing records have the same unique key as new records, the existing records are automatically replaced with the new records (407). Where new records have a unique key that is not present in the existing data, the new records are added.

The server system examines the list of product IDs submitted with each scheme record and creates grouping records to link products to schemes (408).

It is also preferable that a supplier or manufacturer of products can upload, edit or delete products on the database and/or associate products with a scheme on the database, from a local terminal on the network.

The process of uploading, editing or deleting products is substantially identical to that described above for the scheme data with the supplier/manufacturer having to register on the database. For each product, the supplier/manufacturer will preferably specify the product name, the location of one or more image files of the product, one or more characteristics of the product such as a description or keywords, a universal “key” for that product that in the same way as the unique scheme key preferably remains unchanged, a list of scheme IDs (or similar references) of schemes that show the product, the manufacturer of the product, the supplier of the product, a URL to the product on a supplier's website and the price of the product.

The upload process preferably automatically validates the information as detailed above for the scheme data, such validation includes, but is not limited to, ensuring that the unique product key is not duplicated and that all referenced schemes exist. Errors are reported in the same manner as detailed above.

The upload process, as for the uploading of scheme data, preferably includes at least partial manual validation by the service provider. The upload process preferably automatically creates records in a “grouping” table where scheme IDs are referenced in the product details. Furthermore, the product upload process preferably splits the uploaded data into records for both the “product” table 103 and the “stock” table 105. Data on the supplier, the URL and the price is stored in the “stock” table whilst other product information is stored in the “product” table. The data is split since multiple suppliers may stock the same product and upload product data independently. In this instance if the same product ID is detected from two suppliers, a single “product” record and a plurality of “stock” records are automatically created. The splitting of data between the product and stock tables may either happen physically resulting in two tables or, alternatively, may be done where the uploaded information is stored in its raw format. A query is preferably used to generate the product and stock records in real time.

Referring to FIG. 5 there is shown a process flow of a furniture supplier uploading their product catalogue into the system. The process flow is, as detailed above, substantially identical to the process flow of FIG. 4.

Where existing records have the same unique key as new records, the existing records are replaced with the new records (507), however any changes by the service provider such as added keywords are retained.

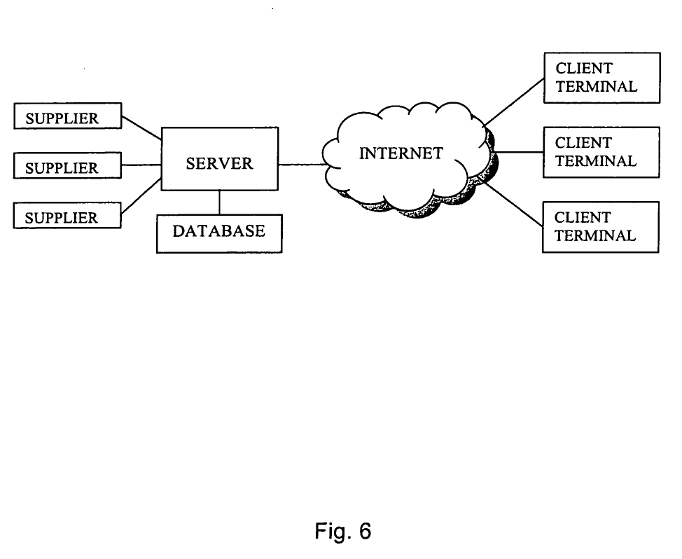

Referring to FIG. 6, there is shown a schematic of a network suitable for the implementation of the present invention. It should be noted that whilst there is a single server shown there may be a number of servers provided, with the servers each storing a copy of the database or each accessing a single database. Whilst the network is shown to include the Internet, the system may be implemented using any suitable network arrangement.

The user terminals may be PCs or other computers, mobile devices, domestic appliances or other connectable devices.

1. A computer network comprising at least one local terminal, at least one database terminal remote from the or each local terminal and a server database associated with the or each server database terminal, wherein the server database comprises a first table that includes a plurality of scheme images from disparate original sources, each scheme image containing a plurality of products from disparate original sources, a second table that includes data relating to the plurality of products from disparate original sources and a third table that includes information referencing which of the plurality of products appears in which of the plurality of scheme images.

2. A computer network comprising at least one local terminal, at least one database terminal remote from the or each local terminal and a server database associated with the or each server database terminal, wherein the server database comprises a “scheme” table that includes a plurality of schemes from disparate original sources, each scheme record including one or more images of the scheme showing a plurality of products from disparate original sources and one or more further metadata fields representative of the characteristics of the scheme, a “product” table that includes data relating to the plurality of products from disparate original sources, each product record including one or more images of the product and one or more further metadata fields representative of the characteristics of the product, a “grouping” table that includes relational data that links product records with scheme records whose images show those products and where any individual product may appear in any number of schemes, and a “stock” table that includes details of a plurality of suppliers that stock the products.

3. A computer network as claimed in claim 1 or 2, wherein the or each local terminal and the or each database terminal are arranged to communicate with each other through the Internet, and the plurality of disparate original sources from which the products are taken comprises a plurality of disparate original websites.

4. A method of locating artistic design ideas using a computer network according to claim 1 or 2, comprising the steps of:
inputting search criteria at the local terminal to locate scheme images stored on the database terminal; and
selecting one of the scheme images.

5. A method as claimed in claim 4, wherein upon initial input a general scheme is provided to the user local terminal corresponding with the initial input, and further inputs from the local terminal cause specific items or data regarding the scheme to be supplied; for selection.

6. A method of selecting a product using a computer network according to claim 1 or 2, comprising the steps of:
inputting search criteria at the local terminal to locate a scheme image stored on the database terminal; and
selecting a product located within the image.

7. A method as claimed in claim 6, wherein upon selection of a specific product, details relating to at least one supplier of the product are displayed and the user may select the supplier in order to access a website of the supplier.

8. A method as claimed in claim 6, further comprising the steps of:
choosing to view other products stored on the database terminal with the same or similar metadata as the initial product selection; and
selecting an alternative product.

9. A method as claimed in claim 6, further comprising the steps of:
locating a product; and
choosing to view those scheme images stored on the database terminal that show the product.

10. A computer network as claimed in claim 1, wherein the database is adapted so that it may be at least partially populated by a user from the at least one local terminal.

11. A computer network as claimed in claim 22, wherein the user may upload scheme or product entries to the database and edit or delete scheme or product entries previously uploaded by the user.

12. A method of populating a database using the computer network of claim 1 or 2, comprising the steps of:
registering a “content owner” user on the database;
allocating the user authentication data;
providing the user at least partial access to the database when logged on to the database server from the or each local terminal, so that the user may upload data to the database; and
at least partially validating data uploaded by the user.

13. A method as claimed in claim 12 wherein the authentication data is a user name and password.

14. A method as claimed in claim 12 further comprising the steps of automatically validating data uploaded by “content owner” users and processing and splitting that data into a database terminal relational model.

15. A method enabling a consumer to select goods, comprising the steps of:
populating a database with products from a plurality of disparate sources, there being one or more images associated with each of the products;
populating a database with schemes from a plurality of disparate sources, there being one or more images associated with each of the schemes;
arranging the products into groups where each group is represented by at least one of the schemes;
providing a means by which the consumer may search the images of grouped products using image and/or product identifiers; and
providing means by which the consumer may select a desired product from a selected group.

16. The method of claim 15, whereby there is additionally provided a means by which the consumer having selected a product or its alternative may directly access one or more of the disparate sources in order to purchase the product.

17. A database, populated with a plurality of schemes, each including data representative of a plurality of products brought together to form a scheme having desired characteristics, the database includes one or more further fields representative of individual items forming part of the scheme and of characteristics of the scheme.

18. The database of claim 17, wherein the product table includes images of the products in isolation.

19. The database of claim 17, wherein the product table includes data relating to characteristics of the products.

20. The database of claim 17, wherein the further fields, include one or more of a “scheme” table, a “grouping” table, a “product” table, a “company” table and a “stock” table.

21. A product selection system comprising a server means, and a database as claimed in claim 17, wherein the server means is adapted to provide, to a remote user terminal, data representative of a scheme and/or the further fields.

22. A computer network as claimed in claim 2, wherein the database is adapted so that it may be at least partially populated by a user from the at least one local terminal.
